(19) United States
(12) Patent Application Publication
(10) Pub. No.: US 2009/0059767 A1
(43) Pub. Date: Mar. 5, 2009

(54) Optical Pick-Up Apparatus and Information Record and Reproduction Apparatus

(75) Inventor: Ikuya Kikuchi, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 11/918,352

(22) PCT Filed: Mar. 31, 2006
(86) PCT No.: PCT/JP2006/306807

§ 371 Date: May 6, 2008

(30) Foreign Application Priority Data
Apr. 15, 2005 (JP) 2005-118767

(51) Int. Cl. G11B 7/00

(52) U.S. Cl. 369/112.16

(57) ABSTRACT

To reduce energy loss on an optical path and improve efficiency of using light volume of light source. A light beam in a P polarized state is emitted from a semiconductor laser 11, and simultaneously a first and second active λ/2 plates 1411 and 1412 are provided in a light path separation/composition unit 14. These first and second active λ/2 plates 1411 and 1412 are for example made of a liquid crystal panel, functions as a λ/2 plate in a turned-off state, and simply functions as a transmission film in a turned-on state. These turned-off and turned-on states are switched over in accordance with types of optical disc, and the optical beam with its polarized state controlled is separated with a third PBS 143. As a result, the light beam is irradiated onto the optical disc DK through a first objective lens 161 in the turned-off state of these first and second active λ/2 plates 1411 and 1412 and through a second objective lens 162 in the turned-on state thereof.

### TECHNICAL FIELD

The present invention relates to an optical pick-up apparatus and an information record and reproduction apparatus used for record and reproduction of information with respect to an optical recording medium such as an optical disc.

### BACKGROUND ART

In recent years, in the field of an optical disc such as a compact disc (CD) or a digital versatile disc (DVD), rapid improvement in recording density is being achieved. Recently, an optical disc which records and reproduces data by use of blue laser light (wavelength 405 nm) (for example, Blue-ray Disc (BD)) or a high-definition DVD (hereinafter referred to as “HD-DVD”) are standardized. On the other hand, even when an optical disc having a new recording format appears, it is assumed to take a substantial time until replacement of the optical discs are completely done, and a CD and a DVD are expected to be widely distributed in future, too. In consideration of such a circumstance, there arises a big problem of how to record and reproduce information with one apparatus onto and from an optical disc, corresponding to the plurality of recording formats (for example, CD, DVD, and BD), in other words, how to realize compatibility.

Here, as a method generally used to realize such compatibility, a method for using a so-called compatible objective lens (that is, an objective lens having numeric apertures on its inner surface side and its outer surface side differ) can be raised. However, with the increased recording density in recent years, numeric aperture of the objective lens is also increased (for example, in case of BD, NA=0.85) and with the increased numeric aperture, effect of spherical aberration (for example, spherical aberration due to difference in protective layer thickness) is becoming larger. Therefore, it is not optimal to use a compatible objective lens, which is apt to cause spherical aberration. Because of such the circumstances, there is proposed a measure of providing a plurality of objective lenses in an optical pick-up apparatus and changing the objective lens used depending on types of optical disc subjected to recording or reproduction with respect to the optical disc to thereby reduce influence of spherical aberration in recording or reproducing information (vide Patent Document 1).

Patent Document 1: Japanese Unexamined Patent Publication No. H10-112060

### DISCLOSURE OF THE INVENTION

### Problem to be Solved by the Invention

Meanwhile, in the optical pick-up apparatus described in the Patent Document 1, there is employed a measure of separating (subject to spectroscopy) light beam emitted from a light source with an optical prism in a ratio of 1 to 1, and the light beam thus separated is respectively inputted into different objective lens. Therefore, efficiency of using light from the light source is limited to 50% as a theoretical maximum volume, and no more improvement in efficiency can be expected. Especially, as for a high recording density type optical disc such as BD or HD-DVD, because it is required to narrow converging spot diameter on a surface of a disc, and at the same time, there is a possibility that record or reproduction of information cannot be ordinarily carried out because of increment of the energy density on the converging spot.

The present invention is made in consideration of such circumstances. An example of the object is to provide an optical pick-up apparatus and an information record and reproduction apparatus, both of which can reduce energy loss in, a light path and improve the efficiency in using light from a light source.

### Means for Solving Problem

To solve the above-mentioned problem, according to the first aspect of the present invention, an optical pick-up apparatus recited in Claim 1 is an optical pick-up apparatus which converges a light beam onto each of optical recording mediums having different specifications and receives reflected light of the light beam, reflected on the optical recording medium, including:

an emission means for emitting the light beam in a state that the light beam is polarized into a first direction;

a light receiving means for receiving the reflected light;

a polarization means for causing the polarization state of the light beam emitted from the emission means only in a case where the optical recording medium corresponds to a predetermined specification;

a first light convergence means for converging the light beam thus polarized into the first direction on the optical recording medium;

a second light convergence means for converging the light beam thus polarized into the second direction to the optical recording medium; and

a light guide means for (a) guiding the light beam polarized in the first direction to the first light convergence means while guiding the light beam polarized in the second direction to the second light convergence means, and further (b) guiding the reflected light to the light receiving means.

According to another aspect of the present invention, there is provided an information record and reproduction apparatus recited in claim 10 is an information record and reproduction apparatus including:

the optical pick-up apparatus according to any of claims 1 to 9;

a drive means for driving the optical pick-up apparatus;

a control means for controlling record and reproduction of information with respect to the optical recording medium by controlling the drive means; and

an output means for outputting a signal corresponding to result of the received light on the optical pick-up apparatus.

### BRIEF DESCRIPTION OF THE DRAWINGS

FIG. 1 A block diagram for showing configuration of an information record and reproduction apparatus RP in a first embodiment.

FIG. 2 A block diagram for showing configuration of an information record and reproduction apparatus RP2 in a second embodiment.

FIG. 3 A diagram for showing relationship between a track pitch of an optical disc DK and converging spot position.

FIG. 4 A diagram for showing configuration and function of diffraction unit 1400 in the second embodiment.

FIG. 5 A diagram for showing relationship between an OEIC 18 and a spot position when DPP method is applied in the second embodiment.

FIG. 6 A block diagram for showing configuration of an information record and reproduction apparatus RP3 in a third embodiment.

FIG. 7 A diagram for showing reflection characteristics of dichroic PBS in a modified example of the third embodiment.

### DESCRIPTION OF THE REFERENCE NUMERALS

RP, RP2, RP3: information record and reproduction apparatus
SP: signal processing unit
C: control unit
D: drive circuit
PU, PU2, PU3: optical pick-up apparatus
AS: actuator servo circuit
SS: step motor servo circuit
P: reproduction unit
DD: optical disc discriminating circuit

### THE BEST MODE FOR CARRYING OUT THE INVENTION

Hereafter, embodiments of the present invention will be explained. Before this, basic principle of the present invention will be explained.

### [1] Basic Principle

As described above, in consideration of increment of numeric apertures in objective lens, it is ideal to provide different objective lenses respectively for recording formats. However, from a viewpoint of preventing energy loss on a light path, it is not good idea to apply a method for separating light path by use of an optical element such as a simple optical prism (a prism of simply separating incident light in a ratio of 1 to 1), which may cause large energy loss. Accordingly, in completing the present invention, an optical system is designed mainly from a viewpoint of how to reduce energy loss in an optical path while following a configuration of providing a plurality of objective lenses in an optical pick-up apparatus.

On the other hand, in recent years, a plurality of recording formats which carry out record and reproduction by use of a light beam having an identical wavelength such as BD and HD-DVD are standardized. In the future, there is a high possibility that a plurality of recording formats having such a relationship will be formulated. Therefore, in realizing compatibility in an information record and reproduction apparatus, both cases where wavelength of light beams used to record and reproduction of information are (a) same and (b) different are need to be assumed, and in either case, it is required to suggest a method which can reduce energy loss in a light path and improve efficiency in utilizing light volume of light source.

From the above viewpoint, in the present invention, following method is adopted. First, for example, (A) an optical element which can change optical rotation by an electric or physical method (that is, characteristics of a medium which polarizes polarization plane of transmitted light) is provided in a light path of the optical pick-up apparatus (for example, such as a liquid crystal panel being λ/2 plate in a switched-off state and a transmission film in a switched-on state) to change optical rotation in response to the types of optical disc, or (B) a wavelength plate provided in a light path is physically moved to change polarization condition of the light beam in response to the types of optical disc. Then, behind the optical element (specifically, on the optical disc side), an optical element such as a polarized light beam splitter (PBS) having a function of separating a light beam according to the polarization condition of the light without causing loss of light volume, and with this optical element, a light path of light beam is changed to thereby change an objective lens to be used. Adopting such a measure makes it possible to change a light path without providing an optical element which causes large loss of energy on a light path irrespective of whether or not wavelength of a light beam is the same. Therefore, it becomes possible to drastically improve efficiency in utilizing light volume from the light source.

Hereafter, embodiments of the present invention using such the measure will be described.

### FIRST EMBODIMENT

### 1.1 Configuration of First Embodiment

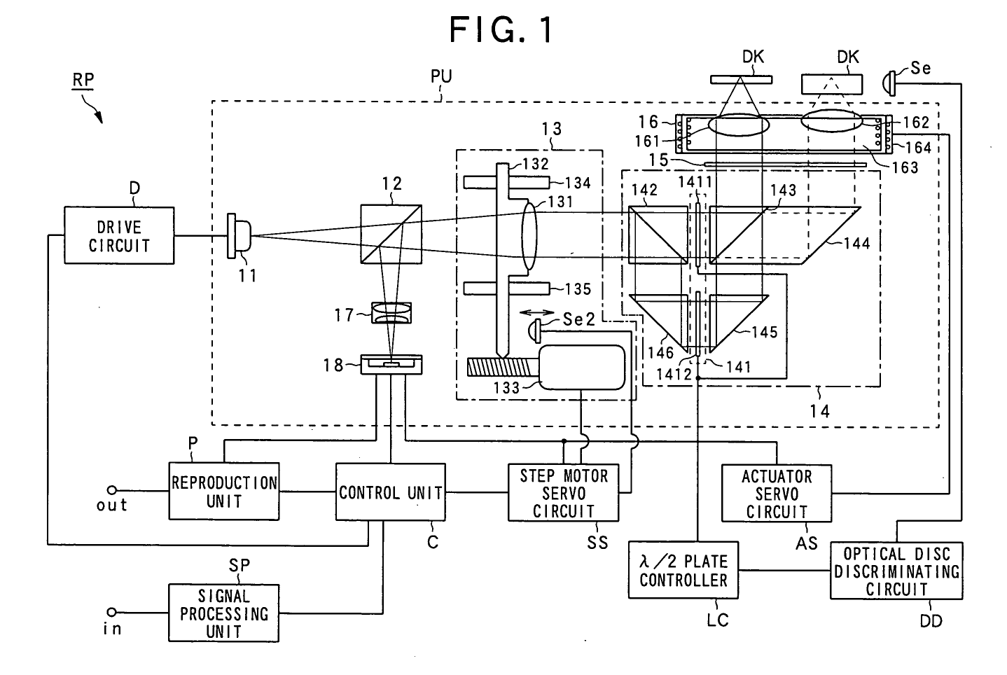

First, a schematic configuration of an information record and reproduction apparatus RP according to a first embodiment of the present invention is shown in FIG. 1. In the information record and reproduction apparatus RP, an optical pick-up apparatus of the present invention is applied to a compatible recorder which performs recording and reproduction of information to and from an optical disc DK and is compliant with both the BD and HD-DVD recording formats (so-called 1 beam 2-disc type compatible recorder).

As shown in the figure, the information record and production apparatus RP according to the present embodiment includes, broadly classifying, a signal processing unit SP, a control unit C, a drive circuit D, an optical pick-up apparatus PU, an actuator servo circuit AS, a step motor servo circuit SS, a λ/2 plate controller LC, a reproduction unit P, and an optical disc discriminating circuit DD.

The signal processing unit SP includes an input terminal. Data that are inputted from outside through this terminal are subjected to signal processing in a predetermined form and outputted to the control unit C. Content of the process performed by the signal processing unit SP is arbitrary. For example, after compressing data inputted by compression technology such as moving picture experts group (MPEG), the data may be outputted to the control unit C.

The control unit C mainly includes a central processing unit (CPU), and controls various units of the information record and reproduction apparatus RP. For example, when data are recorded onto the optical disc DK, the control unit C outputs a drive signal for record which corresponds to data, inputted from the signal processing unit SP, to the drive circuit D. On the other hand, when data recorded in the optical disc DK are reproduced, a drive signal for reproduction is outputted to the drive circuit D.

The drive circuit D is mainly configured by an amplifier circuit. After amplifying a drive signal inputted from the control unit C, the drive circuit D provides the signal to the optical pick-up apparatus PU. Amplification factor in the drive circuit D is controlled by the control unit C. In a case where data are recorded on the optical disc DK, the amplification factor is controlled so that a light beam having power for record is outputted from the optical pick-up apparatus PU. Here, the “power for record” means quantity of energy which causes phase change or pigment color change in optical disc DK of phase change type (for example, BD) or optical disc DK of pigment color change type (for example, HD-DVD-R). Meanwhile, in a case where reproducing data recorded on the optical disc DK are reproduced, amplification factor is controlled so that a light beam having the power for reproduction (i.e., the quantity of energy that does not cause change in the optical disc DK such as pigment color change) is outputted from the optical pick-up apparatus PU.

The optical disc discriminating circuit DD detects a type of the optical disc DK inserted into an optical disc insertion unit (not shown) of the information record and reproduction apparatus RP (that is, whether the disc is BD or HD-DVD) and provides a detection signal indicating result of detection to the λ/2 plate controller LC. A method for detecting the type of the optical disc DK is arbitrary. For example, although the disc itself is accommodated into a cartridge in case of BD, a cartridge is not provided in case of HD-DVD. Therefore, the type of optical disc DK may be detected by detecting with a sensor Se whether or not a cartridge is provided for the optical disc DK when the disc is inserted.

Subsequently, the optical pick-up apparatus PU is an element for recording and reproducing information to and from the optical disc DK by irradiating a light beam to the optical disc DK and includes a semi-conductor laser 11, a first polarized light beam splitter (PBS) 12, an aberration correction mechanism 13, a light path separation/composition unit 14, a λ/4 plate 15, an actuator unit 16 having a first objective lens 161 and a second objective lens 162, an error detection lens 17, and an OEIC 18. Here, an “optical guiding means” in a scope of claims corresponds to, for example, the first PBS 12, the aberration correction mechanism 13, and the light path separation/composition unit 14 in the present embodiment. However, the means does not always require all of these elements and will be described later.

In the optical pick-up apparatus PU, according to specifications of the optical disc DK to be a target of record/reproduction of information, the objective lenses 161 and 162 to be used are switched over and (a) when information is recorded or reproduced to or from BD, the record/reproduction of information is carried out by use of the first objective lens 161. Meanwhile (b) when information is recorded to or reproduced from HD-DVD, the second objective lens 162 is used to record/reproduce information.

Hereafter, elements configuring the optical pick-up apparatus PU will be respectively explained.

First, the semi-conductor laser 11 emits a light beam having a wavelength of 405 nm on the basis of a drive signal supplied from the drive circuit D. The semi-conductor laser 11 also emits a light beam of linearly polarized light (P polarized), and the semi-conductor laser 11 is positioned so that the light beam is incident to the first PBS 12 in a P-polarized state. The first PBS 12 is an outward route/inward route separation element provided on a light path of a light beam emitted from the semi-conductor laser 11 while allowing p polarized incident light to transmit, reflects S polarized incident light. Due to such a function of the first PBS 12, the light beam emitted from the semi-conductor laser 11 is guided to the aberration correction mechanism 13, and reflected light from the optical disc DK is simultaneously guided to the error detection lens 17. Here, the word “outward route” means a direction in which the light beam emitted from the semi-conductor laser 11 is guided toward the optical disc DK, and “inward route” means a direction in which the reflected light from the optical disc DK is guided toward the OEIC 18.

Next, the aberration correction mechanism 13 is an element provided to carry out aberration correction for a light beam incident from a side of the first PBS 12 and a reflected light from the optical disc DK. The aberration correction mechanism 13 includes a collimator lens 131 for converting a part of the light beam incident through the first PBS 12 to an approximately parallel light. The collimator lens 131 is fixed to a lens holder 132. The lens holder 132 is supported so as to be movable in parallel with a light axis direction with a main axis 134 and a conjugate axis 135, and is configured to move in a parallel with the light axis direction along with revolution drive of a step motor 133 based on a drive signal provided from the step motor servo circuit SS. According to such the mechanism, the collimator lens 131 moves in the light axis direction, whereby emitted light from collimator lens 131, i.e. incident light to the first objective lens 161 and the second objective lens 162, is diffused or converged to realize aberration correction function.

Then, while the light path separation/synthesis unit 14 separates a light beam emitted from the collimator lens 131 into two different light paths to cause the light beam be incident into the actuator unit 16, the light path separation/composition unit 14 synthesizes light paths of reflected light incident through different light paths from the actuator unit 16 and causes the reflected light to be incident into the collimator lens 131.

To realize such a function, the light path separation/composition unit 14 according to the present embodiment includes, broadly classifying, a polarization condition conversion unit 141, a second PBS 142, a third PBS 143, a first mirror 144, a second mirror 145, and a third mirror 146.

Among these elements, the second PBS 142 is an optical element provided to compose an outward route and inward route The third PBS 143 is an element for separation of an outward route according to polarization condition of a light beam transmitted through the polarization condition conversion unit 141. The PBSs 142 and 143 have a function of reflecting an S polarized light beam while allowing P polarized light beam to transmit therethrough.

Meanwhile, the polarization condition conversion unit 141 is an element for changing polarization direction of incident light and includes a first active λ/2 plate 1411 and a second active λ/2 plate 1412. Each of the active λ/2 plates 1411 and 1412 functions as a λ/2 plate when both are in an off state, functions as permeate film when both are in an on state. In order to realize such the function, the first and second active λ/2 plates 1411 and 1412 has a configuration such that twisted-nematic (TN) liquid crystal is filled between a pair of transparent base plates to which a transparent electrode is provided. In an ordinary liquid crystal panel, a configuration such that a polarization plate is provided on a base board surface of liquid crystal panel. However, in the first and second active λ/2 plates 1411 and 1412, it is necessary to cause the plate to function as simple permeate films when a power source is turned on. Therefore, such a polarization plate is not provided.

Moreover, the active λ/2 plates 1411 and 1412 are controlled to be turned on and off by the λ/2 plate controller LC. <Case 1> in case of recording information onto BD, both of the active λ/2 plates 1411 and 1412 are maintained in a turned-off state so that the plates function as λ/2 plates. Meanwhile, <Case 2> in case of recording information onto HD-DVD, both of the active λ/2 plates 1411 and 1412 are maintained in a turned-on state so that the plates simply function as transmission films.

As a result, in case of recording information or the like on BD, a light beam emitted from the collimator lens 131 passes through the first active λ/2 plate 1411, the light beam is shifted to S-polarized state, and the light beam is guided to the first objective lens 161 after being reflected upward in the figure by the third PBS 143. Meanwhile, in case of recording information or the like to an HD-DVD, a light beam emitted from the collimator lens 131 maintains A P-polarized state even after transmission through the first active λ/2 plate 1411, passes through the third PBS 143, and is guided to the second objective lens 162 after being reflected by the first mirror 144 to upper direction in the figure.

Thus, in a case where the light path separation/composition unit 14 has such the configuration, by use of the PBS (depending on the polarization condition of incident light, 100% of the light is transmitted or reflected (theoretical value)) and by use of the mirror (reflects 100% of incident light (theoretical value)), separation/composition of outward and inward routes can be performed. Therefore, loss of energy in the light path can be theoretically maintained to be “0%”. As a result, the information record and reproduction apparatus PU according to the present embodiment can make efficiency of utilizing light volume from a light source to be 100% (theoretical value) (in an actual optical system, it is empirically required to be able to achieve efficiency of utilizing of about 95%).

Meanwhile, in the present embodiment, because there is adopted a configuration of carrying out aberration correction with the aberration correction mechanism 13, it is required to employ a configuration in which a light beam (reflected light) is guided to the collimator lens 131 on both outward and inward routes. However, because in the optical pick-up apparatus PU of the present embodiment, a configuration of providing the λ/4 plate 15 is used, the outward and inward routes have different polarization directions by π/2, and a light path on the outward route and the light path on the inward route cannot be approximately the same light paths. Therefore, in the light path separation/composition unit 14 of the present embodiment, the second PBS 142, the second mirror 145, and third mirror 146 are provided to thereby configure a light path for the inward route different from that of the outward route. These elements are not essential elements for the “guiding means” in the scope of claims, and it is for example possible to provide the error detection lens 17 and the OEIC 18 at a position where emitted light from the third PBS 143 is directly receivable (for example, beneath the third PBS 143 in the figure), and further interpose a collimator lens therebetween.

The mode of transmitting a light beam in the light path separation/composition unit 14 will be described in detail when the operation is described below.

Next, the actuator 16 includes a first objective lens 161 for BD, a second objective lens 162 for HD-DVD, an objective lens holder 163 for fixing both the objective lenses 161 and 162 thereto, and a movable mechanism 164 for integrally moving the objective lens holder 163 to thereby cause position of the objective lens to change on the basis of a correction signal provided from the actuator servo circuit AS. Thus tracking servo and focus servo are obtainable.

The error detection lens 17 converges reflection light from the optical disc DK, reflected by the first PBS 12, to the OEIC 18. The OEIC 18 includes, for example, a photo diode. It receives a light beam irradiated from the error detection lens 17 and outputs a light receiving signal to the control unit C, the reproduction unit P, the actuator servo circuit AS, and the step motor servo circuit SS.

Next, the reproduction unit P includes an adder circuit and an amplifier circuit, and generates a reproduction RF signal based on the light receiving signal thus provided from the OEIC 18. Then, the reproduction unit P provides a predetermined signal process to the reproduction RF signal and output this signal to an output terminal OUT.

The actuator servo AS includes a computing circuit, generates a correction signal based on the light receiving signal thus provided from the OEIC 18 of the optical pick-up apparatus PU (specifically, a tracking error signal and a focus error signal), and outputs this signal to the actuator unit 16. As a result, in the actuator unit 16, position of the objective lens holder 163 is changed on the basis of the correction signal and tracking servo thereby carrying out focus servo.

In the present embodiment, a specific measure to realize tracking servo can be arbitrarily determined. However, because a special artifice is required to realize a tracking system of irradiating 3 beams (zero-order light and ±first order light) to the optical disc DK (e.g. differential push-pull system and 3-beam system), an example of employing such the method will be explained in second embodiment described later. In the present embodiment, it is assumed that a method for using one beam (e.g. heterodyne method and push-pull method) is adopted. Meanwhile, with regards to a focus servo system, for example, an astigmatic method or a spot size method can be adopted, wherein (a) in case of the astigmatic method, a cylindrical lens may be used as the error detection lens 17 and light receiving unit of the OEIC 18 may be shaped to be divided into four portions, and (b) in a case of the spot size method, a hologram lens may be used as the error detection lens 17 and the light receiving part of the OEIC 18 may be shaped to be divided into two portions.

The step motor servo circuit SS includes an arithmetic circuit and a recording memory (not shown), and drives the step motor 133 on the basis of various sensor provided in the sensor Se2 (e.g. a positioning sensor for detecting position information or initial position of the collimator lens 131), and signals supplied from the OEIC 18 and the signal processing unit SP and being necessary to correct spherical aberration (e.g. envelope signal or spherical aberration error signal, and jitter). Due to such the function of step motor servo circuit SS, it is possible to realize correction of aberration which occurs on a light path of the optical pick-up apparatus PU in the information record and reproduction apparatus RP of the present embodiment.

The method adopted when the step motor servo circuit SS actually drives the step motor 133 can be arbitrarily determined. For example, correction amount corresponding to detection signal value from the sensor Se2 and signal value of the envelope signal may be retained in a memory (not shown) after these are changed to be in a form of table, and the step motor 133 may be driven based on this table.

### [1.2] Operation in First Embodiment

Next, specific operation of the information record and reproduction apparatus RP according to the present embodiment having the above-described configuration will be explained. However, because operation of the information record and reproduction apparatus RP differs between cases of (1) using the BD as the optical disc DK, and (2) using the HD-DVD as the optical disc DK, the explanation will be given respectively of two patterns.

(1) Recording and Reproduction of Information to/from BD

First, a user inserts a BD as an optical disc DK into the information record and reproduction apparatus RP. Then, the disc judgment circuit DD of the information record and reproduction apparatus RP detects that the optical disc DK thus inserted is a BD, and outputs a detection signal indicating the detection result to the λ/2 plate controller LC. On the basis of the detection signal, the λ/2 plate controller LC shifts the first and the second active λ/2 active plates 1411 and 1412 to a turned-off state. As a result, when a light beam passes through the first and the second λ/2 active plates 1411 and 1412, a polarization direction of the light beam is changed by π/2.

In this condition, the user carries out input operation to record information to or reproduce information from the optical disc DK with an operation unit (not shown). Then, the control unit C starts to provide a drive signal to the drive circuit D in response to the input operation. At this time, when the operation instructs recording of information, the control unit C provides a drive signal corresponding to a signal provided from the signal processing unit SP to the drive circuit D. Simultaneously the control unit sets the amplification factor in the drive circuit D to be a value corresponding to recording power. Moreover, in a case where the operation is to instruct reproduction of information, the control unit C provides a drive signal for reproduction to the drive circuit D, and at the same time sets up the amplification factor in the drive circuit D to be a value corresponding to reproduction power.

On the other hand, when a drive signal is provided from the control unit C, a signal is started to be supplied from the drive circuit D to the semi-conductor laser 11, and the semi-conductor laser 11 is ready for emitting a light beam (wavelength 405 nm, P polarized) on the basis of the signal thus provided. The light beam thus emitted passes through the first PBS 12, is converted to be an approximately parallel light in the collimator lens 131 of the aberration correction mechanism 13, thereafter passes through the second PBS 142, and inputted into the first active λ/2 plate 1411.

Here, in the present example of operation, because the first active λ/2 plate 1411 is in a turned-off state, the light beam is caused to shift to an S polarized state of which polarization direction is changed by π/2 when the light beam passes through the first active λ/2 plate 1411. As a result, the light beam is upward reflected in the figure by the third PBS 143, passes through the λ/4 plate 15 to be shifted to a state of circularly polarized light and thereafter is concentrated on the recording surface of the optical disc DK with the first objective lens 161.

The light beam thus converged on the recording surface of the optical disc DK is reflected on the recording surface toward lower part in the figure, passes through the first objective lens 161 as reflected light, and passes through the λ/4 plate 15 again. As a result, the reflected light is shifted to a P polarized state that a polarization direction is differed by π/2 from the outward route thereby being enabled to permeate through the third PBS 143 without being reflected by the third PBS 143.

Then, the reflected light passes through the third PBS 143, is reflected by the second mirror 145 to a leftward direction in the figure, and is incident to the second active λ/2 plate 1412. In the present embodiment, in a similar manner to the first active λ/2 plate 1411, the second active λ/2 plate 1412 is in the turned-off state. Therefore, the polarization direction of the reflected light is changed by π/2 when the reflected light passes through the second active λ/2 plate 1412, and the light is shifted to an S-polarized state. Thus, the reflected light which is shifted to an S-polarized state is reflected upward in the figure by the third mirror 146, reflected to leftward in the figure by the second PBS 142, passes through the collimator lens 131, is reflected to lower part in the figure by the first PBS 12, and is converged to the OEIC 18 by the error detection lens 17.

Meanwhile, after receiving reflected light thus concentrated, the OEIC 18 outputs light receiving signal corresponding to the reflected light to the reproduction unit P and control unit C, and further to the actuator servo circuit AS and the step motor servo circuit SS. As a result, for example, when reproducing the information, a signal corresponding to information recorded in the optical disc is outputted from the reproduction unit P. Moreover, for example, an amplification factor of the drive circuit D is controlled with the control unit C and light volume of the light beam emitted from the semi-conductor laser 11 is controlled. At the same time, the actuator unit 16 is driven by the actuator servo circuit AS to thereby realize each of the tracking and focus servos. Furthermore, the step motor 133 is driven to realize aberration correction by the step motor servo circuit SS.

(2) Recording and Reproducing Information with Respect to HD-DVD

Meanwhile, when a user inserts an HD-DVD as an optical disc DK into the information record and reproduction apparatus RP, the optical disc discriminating circuit DD judges that the optical disc DK thus inserted is an HD-DVD and outputs a detection signal indicating the detection result to the λ/2 plate controller LC. On the basis of the detection signal, the λ/2 plate controller LC shifts the first and second active λ/2 plates 1411 and 1412 to be in a turned-on state (i.e. state that the plates simply function as permeating films).

In this condition, when the user performs a predetermined input operation to an operation unit (not shown), the control unit C starts to provide a drive signal to the drive circuit D in accordance with the input operation, and a P polarized light beam is resultantly emitted from the semi-conductor laser 11. Then, the light beam passes through the first PBS 12 and the collimator lens 131. Thereafter, this light beam passes through the second PBS 142 of the light path separation/composition unit 14 and is incident into the first active λ/2 plate 1411.

In case of the present operation example, since the first active λ/2 plate 1411 is maintained to be turned-on state, the light beam irradiated from the second PBS 142 passes through the first active λ/2 plate 1411 and is incident into the third PBS 143 in the P-polarized state without changes in polarization direction. As a result, the light beam passes through the third PBS 143 without being reflected, is reflected upward in the figure by the first mirror 144, passes through the λ/4 plate 15, is shifted to be in a circularly polarized light state, and is converged on a recording surface of the optical disc DK by the second objective lens 162.

Thus, the light beam converged on the recording surface of the optical disc DK is reflected downward in the figure on the recording surface, passes through the second objective lens 162 as reflected light, and thereafter passes through the λ/4 plate 15 again. Therefore, the polarization direction of the light differs by π/2 from the outward route, and the light beam which is in a P-polarized state on the outward route is shifted to an S-polarized state on the inward route. As a result, the reflected light is leftward reflected in the figure by the first mirror 144, reflected by the third PBS 143 toward a lower side in the figure, leftward reflected by the second mirror 145 in the figure, and is incident into the second active λ/2 plate 1412.

As described above, in the present operation example, because the second active λ/2 plate 1412 is maintained in a turned-on state, the reflected light passes through the second active λ/2 plate 1412 and is reflected upward in the figure by the third mirror 146 while maintaining an S-polarized state without changing polarization direction. Subsequently, the reflected light is reflected leftward in the figure by the second PBS 142, passes through the collimator lens 131, is reflected by the first PBS 12 downward in the figure, and is converged into the OEIC 18 with the error detection lens 17. As a result, the reflected light is received by the OEIC 18 to thereby realize tracking servo and the like.

As such, in the information record and reproduction apparatus RP according to the present embodiment, there is employed a configuration in which the first active λ/2 plate 1411 is provided on a light path of the light beam, emitted from the semi-conductor laser 11, to change the polarization condition of the light beam in accordance with the specification of the optical disc DK to be a target of record and reproduction of information, and the light path is separated to guide the light beam to the first objective lens 161 or the second objective lens 162 by use of the third PBS 143.

Due to this configuration, it becomes possible to separate an outward route by use of an optical element such as a PBS or a mirror which has small energy loss. Therefore, it is possible to maintain theoretical energy loss to be “0%”. As a result, the information record and reproduction apparatus RP according to the present embodiment enables to make utilization efficiency of the light volume from the light source to be 100% (theoretical value).

Moreover, in the information record and reproduction apparatus RP according to the present embodiment, it is detected in the optical disc discriminating circuit DD whether the optical disc DK is a BD or an HD-DVD, and the first and second active λ/2 plates 1411 and 1412, configured by liquid crystal panels, are turned on or off depending on the detection result. Therefore, it is possible to separate/synthesize outward and inward routes only with an electronic circuit and it becomes possible to simplify the apparatus and reducing the size of apparatus.

Furthermore, since in the light path separation/composition unit 14 in the present embodiment an emitted light from the first active λ/2 plate 1411 is separated by the third PBS 143, which switches over between reflection and transmission depending on the polarization state of the incident light, and the first mirror 144. Therefore, it is possible to manufacture the optical pick-up apparatus PU without using a special optical element, whereby the manufacturing cost can be reduced.

Furthermore, in the present embodiment, the aberration correction mechanism 13 is provided. Therefore, it is possible to appropriately correct aberration due to difference in thickness of a protection layer of the optical disc DK or aberration due to rotation distortion of the optical disc DK. Especially, in a case of high recording density type optical disc DK such as a BD or an HD-DVD, it is highly necessary to set numeric apertures of the objective lens large and to narrowing down a converging spot. Therefore, there is a great merit on availability of aberration correction.

In the first embodiment, explanation is given of a case where the first and the second active λ/2 plates 1411 and 1412 are made of liquid crystal panels. However, it is also possible to realize a function similar to those of the first and the second active λ/2 plates 1411 and 1412 by physically moving an ordinary λ/2 plate. In this case, for example, as the first and the second active λ/2 plates, an ordinary crystal-type wavelength board may be used, and the wavelength board may be rotated depending on the type of the optical disc DK to be a target of record and reproduction of information, to thereby realize the light path similar to the above described light path. Moreover, for example, the λ/2 plate may be mechanically moved to insert it in a light path at a time of recording or reproducing information with respect to a BD, or to remove it from the light path at a time of recording or reproducing with respect to an HD-DVD.

Furthermore, in the above first embodiment, the explanation is given of a case where compatibility between BD and HD-DVD subjected to record and reproduction by use of light beams having an identical wavelength. However, it is possible to realize compatibility between various optical discs DK subjected to record and reproduction by use of light beams having different wavelength. For example, compatibilities between CD and DVD, between DVD and BD, and between HD-DVD and DVD can be realized. In this case, a light source unit having a plurality of light sources, which respectively emit light beams of different wavelengths, may be provided in place of the semi-conductor laser 11 so that a light beam is emitted from the light source unit.

Furthermore, in the first embodiment, explanation was given of a configuration example in which a PBS which allows P polarized light beam to pass through the third PBS 143 while S polarized light beam is reflected by the third PBS 143 is used. However, as to the reflection/transmission characteristics of the third PBS 143, it is also possible to allow S polarized light beam to pass therethrough and P polarized light beam to be reflected. In this case, as one measure to realize the above, a method to turn on and off the first and the second active λ/2 plates 1411 and 1412 may be changed so that it is turned on at a time of recording and reproducing information with respect to a BD, and turned off at a time of recording and reproducing information with respect to an HD-DVD. Moreover, as another method, while controlling to turn on and turn off in a similar manner to the above embodiment (in the first and second active λ/2 plates 1411 and 1412), positions of installing the first objective lens 161 and the second objective lens 162 may be changed over.

In addition, in the information record and reproduction apparatus RP according to the first embodiment, an explanation was given of an example where the control unit C and the drive circuit D are configured by a device (for example, CPU) other than the optical pick-up apparatus PU. However, these components and the optical pick-up apparatus PU may be integrally configured.

Furthermore, in the first embodiment, a configuration where aberration correction is realized by changing a position of installing the collimator lens 131 is adopted. For example, by use of a beam expander or an aberration correction element configured by a liquid crystal panel, a function similar thereto can be realized. A configuration example of an aberration correction mechanism using a beam expander is similar to the configuration described in Japanese Unexamined Patent Publication No. JP-A-2002-170274, and a specific method for aberration correction in case of using a liquid crystal element is similar to that described in Japanese Unexamined Patent Publication No. JP-A-2002-358690. Therefore, detailed explanation is omitted.

### 1.3 Modified Example of the First Embodiment

There is employed, in the first embodiment, a configuration where the second active λ/2 plate 1412 is positioned between the second mirror 145 and the third mirror 146. However, the installation position of the second active λ/2 plate 1412 is not limited thereto. For example, it may be positioned between the third PBS 143 and the second mirror 145 or between the second PBS 142 and the third mirror 146.

Moreover, there is employed, in the first embodiment, a configuration where the first and the second active λ/2 plates 1411 and 1412 are configured by liquid crystal panels. However, the first and the second active λ/2 plates 1411 and 1412 may be configured in an integrated manner. In this case, the integrated active λ/2 plate may be shaped planar, and installed in a position similar to those in the first and the second active λ/2 plates in FIG. 1. Moreover, the active λ/2 plate may be shaped like L, and positioned between the second PBS 142 and the third PBS 143, between the third PBS 143 and the second mirror 145, or between the second PBS 142 and the third mirror 146.

### SECOND EMBODIMENT

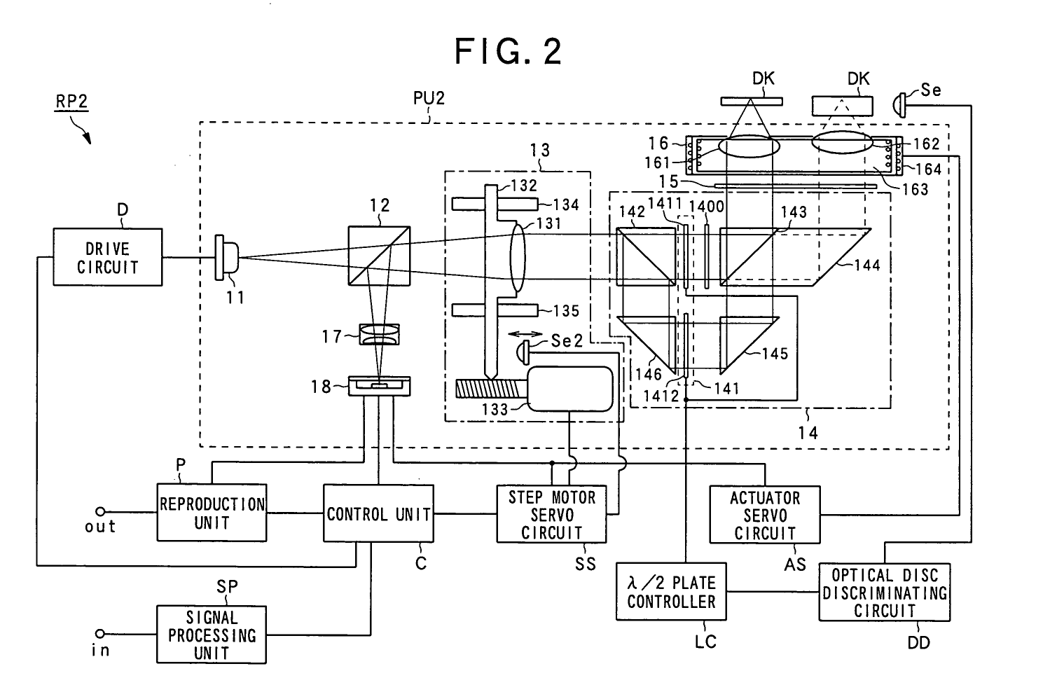

Next, a second embodiment of the present invention will be described with reference to FIG. 2. FIG. 2 is a block diagram showing configuration of an information record and reproduction apparatus RP2 according to the present embodiment, and reference numerals similar to those described in the figure used for elements similar to those in the above-described FIG. 1.

Here, in the information record and reproduction apparatus RP according to the first embodiment, a tracking system using one beam (for example, push-pull method) is adopted. In the information record and reproduction apparatus RP2 according to the present embodiment, a 3-beam method or DPP method is adopted to realize tracking system using 3 beams.

To realize such the function, in the light path separation/composition unit 14 of the present embodiment, a diffraction unit 1400 is provided. The diffraction unit 1400 diffracts incident light to generate zero-order light and ±first order light (hereinafter, zero-order light is referred to as “main beam” and ±first order light is referred to as “sub beam”).

Meanwhile, there is one thing which should be considered in realizing such a 3-beam method.

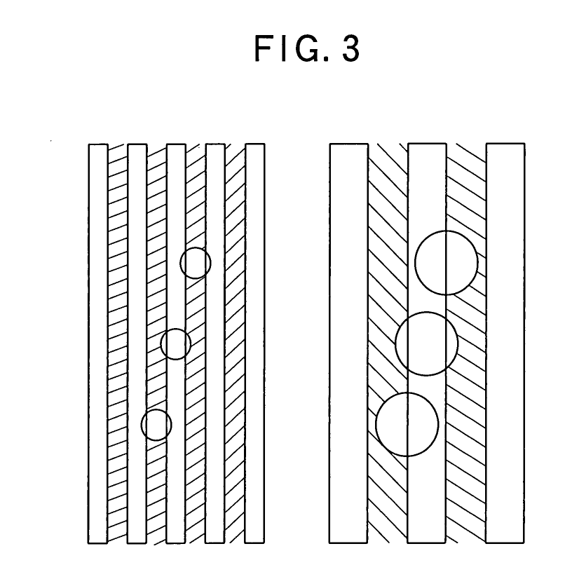

That is, track pitch in BD and track pitch in HD-DVD are different because of difference in recording density. Therefore, when grating is made in accordance with one of these recording formats, it is impossible to render all of the main beams and sub beams an on-track state (i.e. the main beams are rendered an on-track state with respect to a group track, and the sub beams are rendered an on-track state with respect to a land track, vide FIG. 3).

Accordingly, it is required to provide two types of grating having different lattice pitches and angles in the diffraction unit 1400 to realize on-track state on both a BD and an HD-DVD. Here, when wavelength of the light beams differ, it is sufficient to simply provide two types of grating depth. However, in a configuration such that information is recorded onto optical discs DK in compliance with two types of recording format using one wavelength like the present embodiment, there is a problem of how to set two types of grating in the diffraction unit 1400.

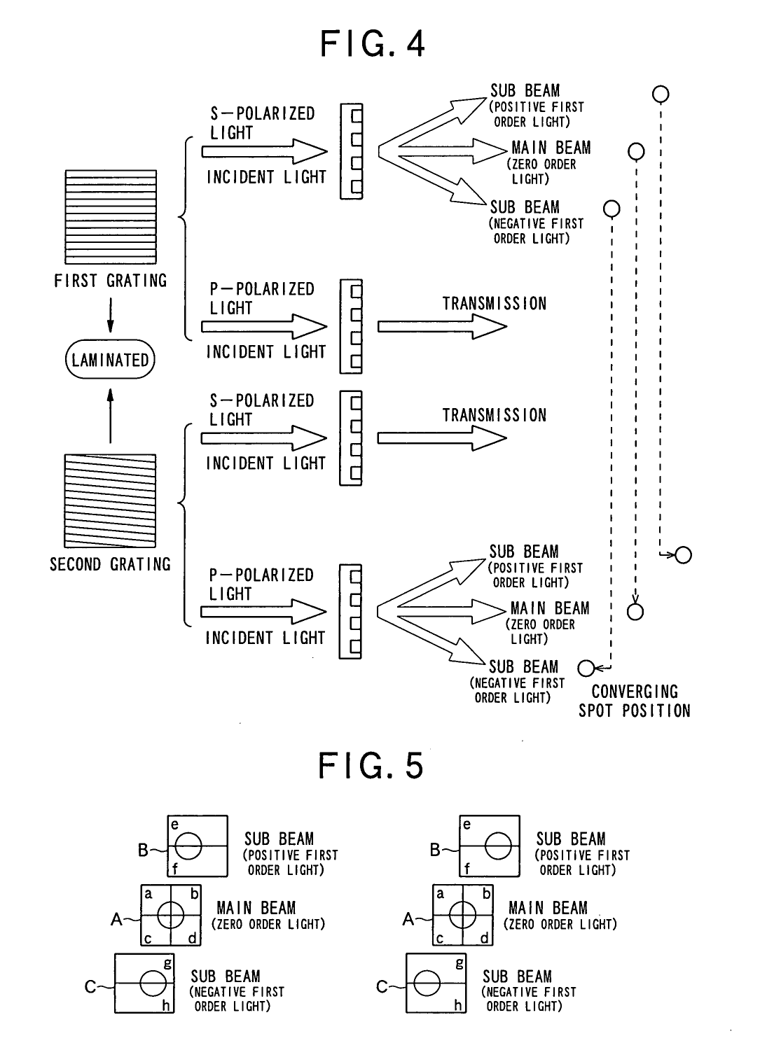

Therefore, as shown in FIG. 4, there is employed a measure in the present embodiment that a first grating for diffracting only S polarized state light beam (polarization hologram) and a second grating for diffracting only P polarized state light beam (polarization hologram) are made and laminated each other to form the diffraction unit 1400. Then, by changing lattice pitches and angles of the first and the second gratings, a converging spot position on the optical disc DK can be changed. As a result, depending on polarization states of a light beam after passing through the first active λ/2 plate 1411, grating functioning on the light beam changes, and it becomes possible to make an on-track state for both a BD and an HD-DVD.

Specific mode of lattice for the first and second gratings can be arbitrarily determined. However, in a case where a DPP system is employed as a tracking system, it is necessary to provide three light receiving elements A, B, C, dividing the light receiving element A into four areas, and dividing the light receiving elements B and C into four areas a, b, c, and d (vide FIG. 5). Then, it is required to acquire a tracking error signal Step on the basis of the following (equation 1) from light receiving signals of each of the light receiving elements A, B, and C having thus divided shapes.

Ste={(a+b)−(c+d)}−k{(e+g)−(f+h)} (Equation 1)

Accordingly, in case of reproducing from either a BD or an HD-DVD, it is required to position a converging spot in a center of the area A with regards to the main beam and to position a converging spot on a center line between the areas B and C with regards to the sub beam, under a condition that there is no tracking error as shown in FIG. 5. Accordingly, when forming the first and second gratings, it is necessary to pay attention to adjust angle and lattice pitch of grating so that converging spot positions of the main beam and the sub beam in the OEIC 18 satisfies these requirements.

Thus, according to the information record and reproduction apparatus RP2 of the present embodiment, it is possible to realize not only a tracking system using one beam, but also a tracking system using three beams. Therefore, degree of freedom in designing the information record and reproduction apparatus RP2 can be improved, and simultaneously accuracy in conducting tracking servo can be improved.

In the second embodiment described above, there is employed a configuration that the diffraction unit 1400 is made by laminating the first and second gratings, and the diffraction unit 1400 is provided in a later stage of the first active λ/2 plate. However, it may be possible to configure the first and second gratings separately, and to position the gratings between the λ/4 plate 15 and the light path separation/composition unit 14. When such the configuration is employed, (1) in the light path on the first objective lens 161 side, a light beam incident to the first grating in an S polarized state in an outward route is incident into the first grating in a P polarized state after shuttling the λ/4 plate 15, and (2) in the light path on the second objective lens 161 side, a light beam incident to the second grating in a P polarized state in an outward route is incident into the second grating in an S polarized state after shuttling the λ/4 plate 15. Therefore, it is possible to prevent another diffraction from occurring and to prepare an appropriate light receiving condition.

### THIRD EMBODIMENT

### [3.1] Configuration and Operation of Third Embodiment

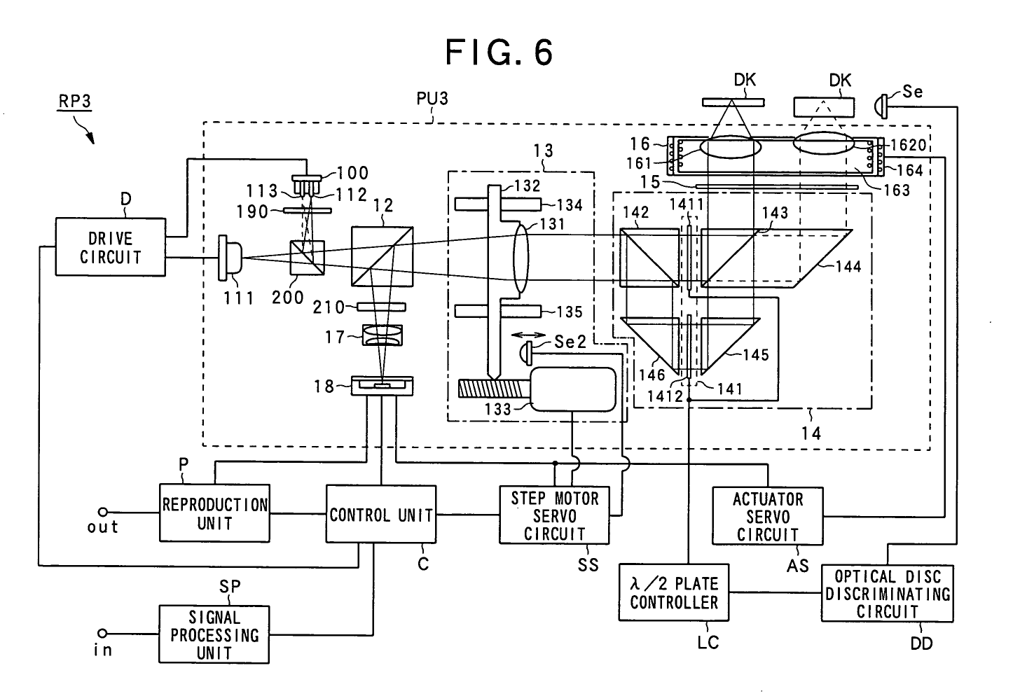

Next, a third embodiment of the present invention will be explained with reference to FIG. 6. FIG. 6 is a block diagram showing configuration of an information record and reproduction apparatus RP3 according to the present embodiment. Reference numerals similar to those in FIG. 1 are used for elements similar to those described with respect to FIG. 1

Here, the information record and reproduction apparatus RP according to the first embodiment records or reproduces information to/from two types of optical disc DK (a BD and an HD-DVD) by use of a light beam having a wavelength of 405 nm. On the other hand, the information record and reproduction apparatus RP3 according to the present embodiment uses three light beams respectively having different wavelengths (specifically, three beams of 405, 650, and 780 nm) to thereby record and reproduce with respect to four types of optical discs of BD, HD-DVD, DVD, and CD.

In order to realize such the function, in the optical pick-up apparatus PU3 of the present embodiment, instead of the second objective lens 162, a compatible objective lens 1620 is provided. The compatible objective lens 1620 is a compatible objective lens corresponding to three recording formats of CD, DVD, and HD-DVD, and are respectively set up to have three numeric apertures (specifically, 0.65, 0.6, and 0.45) for record and reproduction of information with respect to an optical disc DK.

Moreover, there are provided in the optical pick-up apparatus PU3 with three light sources such as a first semi-conductor laser 111 (for BD and HD-DVD), a second semi-conductor laser 112 (for DVD) and a third semi-conductor laser 113 (for CD), respectively emitting light beams having different wavelengths. Among these semi-conductor lasers, the second semi-conductor laser 112 and the third semi-conductor laser 113 are accommodated in a single package of a light source unit 100 to be configured as a so-called 2-laser 1 package. These semiconductor lenses respectively emit a light beam in a P-polarized state.

Further, on a light path of a light beam emitted from each of the semi-conductor lasers 111 to 113, a dichroic mirror 200 is provided, and the dichroic mirror 200 guides a light beam emitted from the first semi-conductor laser 111 to the first PBS 12 by allowing the light beam to pass and reflects a light beam emitted from the light source unit 100 to guide the light beam into the first PBS 12.

In the figure, numeral 210 designates a grating for positioning, provided to adjust a converging spot position on the OEIC 18. The positioning grating 210 is required along with the configuration of the light source formed as described above. In other word, when the optical pick-up apparatus PU3 is manufactured, in a case where light axes of the first semi-conductor laser 11 and the second semi-conductor laser 12 are adjusted to properly position the converging spot on the OEIC 18, installation position of the light source unit 10 is adjusted basically for the second semi-conductor laser 12, there occurs misalignment in the converging spot position on the OEIC 18 with regards to the third semi-conductor laser 13. Therefore, this grating is provided to adjust such the misalignment.

Meanwhile, in case of adopting such the configuration, there arises a problem of in which mode the first and the second active λ/2 plates 1411 and 1412 are controlled. In the information record and reproduction apparatus RP3 according to the present embodiment, (a) at a time of recording/reproducing information with respect to an optical disc DK corresponding to BD format, both of the active λ/2 plates 1411 and 1412 are controlled to be turned off, and on the other hand, (b) at a time of recording/reproducing information with respect to an optical disc DK corresponding to HD-DVD, DVD, or CD format, both of the active λ/2 plates 1411 and 1412 are controlled to be turned on.

As a result, for example when the information is recorded to an optical disc DK corresponding to the BD format, the first and the second active λ/2 plates 1411 and 1412 function as λ/2 plates to shift a polarization state of transmitting light. Meanwhile, for example the information is recorded to an optical disc DK corresponding to the HD-DVD, DVD, or CD format, the first and second active λ/2 plates 1411 and 1412 function as λ/2 plates.

As a result, in the information record and reproduction apparatus RP3, record and reproduction of information with respect to CD and DVD are carried out in a manner similar to the occasion of recording and reproducing information with respect to HD-DVD in the information record and reproduction apparatus RP according to the first embodiment. Because operation at this time is similar to that in the first embodiment, details are omitted.

As such, according to the information record and reproduction apparatus RP3 according to the present embodiment, it is possible to record and reproduce information with respect to four types of optical discs by use of three light beams having different wavelengths to thereby realize improvement in compatibility.

### [3.2] Modified Example of Third Embodiment

In the present embodiment, it is possible to adopt a modified example similar to those in the first and the second embodiments. In the present embodiment, it is further possible to adopt the following configuration.

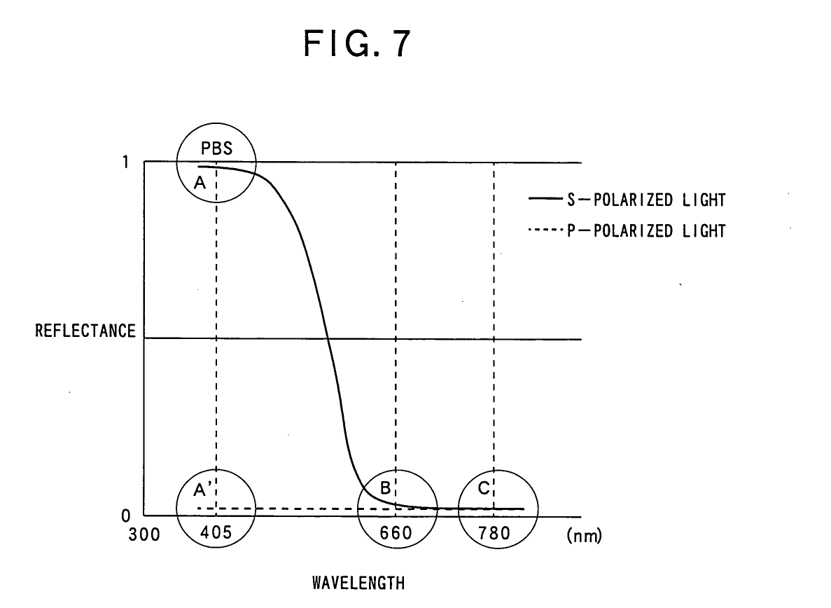

That is, instead of the second PBS 142 and the third PBS 143, a dichroic PBS is used. Here, the dichroic PBS is an element having both of polarization dependence and wavelength dependence with regards to reflection characteristics of light. Reflection characteristics of a light beam in this dichroic PBS will be explained with reference to FIG. 7. In the figure, reflection characteristics of an S polarized light beam is indicated by a solid line, and reflection characteristics of P polarized light beams are indicated by broken lines.

As shown in the figure, the dichroic PBS has a characteristic of allowing almost all P polarized light beams to transmit in all the wavelength areas. On the other hand, the dichroic PBS shows sudden change of transmission-reflection characteristic in a predetermined wavelength area with respect to S polarized light beams. Almost all S polarized light beams are reflected at a wavelength of 405 nm, and almost all S polarized light beams are transmitted at a wavelength of 650 and a wavelength of 780 nm. As a result, the dichroic PBS functions as a PBS (polarized light beam splitter) to a light beam having 405 nm wavelength, but does not have a reflecting characteristics to a light beam having 650 nm or 780 nm wavelength, and in these cases it does not function as a PBS. However, transmission-reflection change shape is not limited to the characteristics illustrated.

In a case that a dichroic PBS is used, with respect to a light beam emitted from the first semi-conductor laser 111, a light path is formed in a mode similar to transmission as in the optical pick-up apparatus PU according to the first embodiment. On the other hand, light beams emitted from the second and third semi-conductor lasers 112 and 113 in the light source unit 100 shuttle via a straight light path from the collimator lens 131 to the mirror 144 on both the outward and inward routes.

Thus, according to this modified example, even when dichroic PBS is used, a function similar to that of the third embodiment can be realized.

1. An optical pick-up apparatus which converges a light beam onto each of optical recording mediums having different specifications and receives reflected light of the light beam, reflected on the optical recording medium, comprising:
an emission device which emits the light beam in a state that the light beam is polarized into a first direction;
an aberration correction device, Provided on a light path of the light beam emitted from the emission device, which corrects aberration occurring in the light beam;
a light receiving device which the reflected light;
a first polarization device which causes the polarization state of the light beam emitted from the emission device only in a case where the optical recording medium corresponds to a predetermined specification;
a first light convergence device which converges the light beam thus polarized into the first direction on the optical recording medium;
a second light convergence device which converges the light beam thus polarized into the second direction to the optical recording medium; and
a light guide device, (a) provided with a first polarization beam splitter that passes the light beam polarized in the first direction therethrough, which guides the light beam, passing through the first polarization beam splitter, to the first light convergence device and guides the light beam, polarized in the second direction, to the second light convergence device; and (b) which guides the reflected light to a second polarization device which changes its polarization state of the reflected light from the optical recording medium to the second direction only in a case where the optical recording medium corresponds to the specification by retrieving averting the first polarization that, guides the reflected light thus polarized in the second direction to the first polarization beam splitter, and converges the reflected light thus reflected by the first polarization beam splitter to the light receiving device through the aberration correction device.

2. The optical pick-up apparatus according to claim 1, further comprising:
a detection device which detects specification of the optical recording medium,
wherein the first and second polarization device detect whether or not the optical recording medium corresponds to a predetermined specification in response to result of the detection.

3. The optical pick-up apparatus according to claim 1,
wherein the first and second polarization device include:
a polarization plate that can electrically change optical rotation; and
a polarization plate control device which electrically controls the optical rotation in the polarization plate.

4. The optical pick-up apparatus according to claim 3, wherein the polarization plate is made of a liquid crystal panel.

5. The optical pick-up apparatus according to claim 1,
wherein the first and second polarization devices include:
a polarization plate having a predetermined optical rotation; and
a moving device which physically changes a position of arranging the polarization plate.

6. The optical pick-up apparatus according to claim 1,
wherein the guiding device includes:
a second polarization beam splitter for guiding the light beam to the second light convergence device by reflecting the light beam, polarized in the second direction, and for allowing the light beam, polarized in the first direction, to pass therethrough, and
a mirror for reflecting the light beam, passed through the second polarization beam splitter to thereby guide the light beam to the first light convergence device.

7. (canceled)

8. The optical pick-up apparatus according to claim 1, further comprising:
a first grating for diffracting the light beam polarized in the first direction; and
a second grating for diffracting the light beam polarized in the second direction,
wherein the first and the second gratings are provided on light paths from the first polarization device to the first light convergence device and from the polarization device to the second light convergence device, respectively.

9. The optical pick-up apparatus according to claim 1,
wherein the emission device further includes:
a first light source for emitting a light beam having a first wavelength;
a second light source for emitting a light beam having a second wavelength;
a third light source for emitting a light beam having a third wavelength; and
a light path composite device that composes light paths of the light beams emitted respectively from light sources and guiding the light beams to the first polarization device via light paths approximately the same.

10. An information record and reproduction apparatus comprising:
the optical pick-up apparatus according to claim 1;
a drive device that drives the optical pick-up apparatus;
a control device that controls record and reproduction of information with respect to the optical recording medium by controlling the drive device; and
an output device which outputs a signal corresponding to result of the received light on the optical pick-up apparatus.
